(19) United States
(12) Patent Application Publication
(10) Pub. No.: US 2016/0066290 A1
(43) Pub. Date: Mar. 3, 2016

(54) Cell Timing Synchronization Via Network Listening

(71) Applicant: Broadcom Corporation, Irvine, CA (US)

(72) Inventors: Yonatan COHEN, Ramat Gan (IL); Sharon LEVY, Binyamina (IL); Rafael CARMON, Rishon Lezion (IL)

(73) Assignee: Broadcom Corporation, Irvine, CA (US)

(21) Appl. No.: 14/475,991

(22) Filed: Sep. 3, 2014

(51) Int. Cl. H04W 56/00

(52) U.S. Cl. CPC H04W 56/0015

(57) ABSTRACT

The present disclosure is directed to a system and method for performing timing synchronization via network listening. The system and method can be implemented in a non-synchronized base station to receive Cell-Specific Reference Signals (CRSs) of a synchronized base station during guard periods of special subframes. To allow the non-synchronized base station to receive the CRSs, the non-synchronized base station can configure one or more of its special subframes to have a shorter downlink part than corresponding special subframes of the synchronized base station. The system and method of the present disclosure can use the received CRSs to synchronize the timing of the non-synchronized base station to the timing of the synchronized base station. To prevent a substantial loss in downlink throughput due to the non-synchronized base station using a shorter DwPTS part, tracking can be performed on a once per multiple radio frame basis.

### TECHNICAL FIELD

This application relates generally to cell timing synchronization, including cell timing synchronization via network listening.

### BACKGROUND

Long-Term Evolution (LTE) networks can operate in either a Frequency Division Duplexing (FDD) mode or a Time Division Duplexing mode (TDD). In the FDD mode, a base station and a mobile device communicate with each other in the uplink and downlink directions at the same time using different carrier frequencies. In the TDD mode, the base station and the mobile device take turns in time communicating with each other in the uplink and downlink directions using a single carrier frequency.

The TDD mode can be advantageous because the network can adjust how much time is allocated to the uplink and downlink directions based on traffic conditions, whereas in the FDD mode the bandwidths of the uplink and downlink are usually fixed and the same. However, cellular networks operating in the TDD mode can experience severe interference if, for example, the downlink transmissions in one cell overlap in time with the uplink transmissions in another nearby cell or vice versa.

To avoid this, cells in cellular networks operating in the TDD mode can be time synchronized such that their respective uplink transmissions are aligned in time and their respective downlink transmission are aligned in time. Current releases of the LTE standard (incorporated by reference herein) specify several techniques for cell timing synchronization, including techniques that use the Global Positioning System (GPS) and/or the timing synchronization protocol defined by the IEEE 1588 standard.

For base stations that have GPS receivers, the base stations can perform the GPS based technique by acquiring GPS synchronization signals and using those signals to synchronize their frame transmission timings to be within less than a microsecond of each other. The problem with this technique is that some base stations either do not have GPS receivers or are located in a place where reception of GPS signals is difficult or impossible, such as in indoor environments.

Similarly, the timing synchronization protocol defined by the IEEE 1588 standard can provide sub-microsecond timing synchronization accuracy but requires a backhaul with small jitter and packet delay variations between the upstream and downstream directions. Because such backhaul conditions are not always present or possible, this timing synchronization technique may also be limited.

### BRIEF DESCRIPTION OF THE DRAWINGS/FIGURES

The accompanying drawings, which are incorporated herein and form a part of the specification, illustrate the embodiments of the present disclosure and, together with the description, further serve to explain the principles of the embodiments and to enable a person skilled in the pertinent art to make and use the embodiments.

FIG. 1 illustrates cell synchronization via network listening in accordance with embodiments of the present disclosure.

FIG. 2 illustrates the general LTE-TDD frame configuration and a table of the specific LTE-TDD uplink/downlink configurations.

FIG. 3 illustrates a table of specific LTE-TDD special subframe configurations.

FIG. 4 illustrates exemplary radio frame patterns for base stations with different synchronization stratums in accordance with embodiments of the present disclosure.

FIG. 5 illustrates an exemplary block diagram of a base station implementing cell synchronization via network listening in accordance with embodiments of the present disclosure.

FIG. 6 illustrates a flowchart of an exemplary method of cell synchronization via network listening in accordance with embodiments of the present disclosure.

FIG. 7 illustrates a block diagram of an example computer system that can be used to implement aspects of the present disclosure.

The embodiments of the present disclosure will be described with reference to the accompanying drawings. The drawing in which an element first appears is typically indicated by the leftmost digit(s) in the corresponding reference number.

### DETAILED DESCRIPTION

In the following description, numerous specific details are set forth in order to provide a thorough understanding of the embodiments of the present disclosure. However, it will be apparent to those skilled in the art that the embodiments, including structures, systems, and methods, may be practiced without these specific details. The description and representation herein are the common means used by those experienced or skilled in the art to most effectively convey the substance of their work to others skilled in the art. In other instances, well-known methods, procedures, components, and circuitry have not been described in detail to avoid unnecessarily obscuring aspects of the disclosure.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

For purposes of this discussion, the term “module” shall be understood to include software, firmware, or hardware (such as one or more circuits, microchips, processors, and/or devices), or any combination thereof. In addition, it will be understood that each module can include one, or more than one, component within an actual device, and each component that forms a part of the described module can function either cooperatively or independently of any other component forming a part of the module. Conversely, multiple modules described herein can represent a single component within an actual device. Further, components within a module can be in a single device or distributed among multiple devices in a wired or wireless manner.

### I. OVERVIEW

The present disclosure is directed to a system and method for performing timing synchronization in a cellular network via network listening. In at least one embodiment, timing synchronization refers to the requirement that the difference in start time between radio frames or symbols transmitted from different base stations is to be within some time range. When the difference in start time between radio frames or symbols transmitted from the different base stations is within the required time range, the base stations can be said to be time synchronized.

As mentioned above, timing synchronization is important in cellular networks that are operating in the TDD mode to reduce interference. For example, without timing synchronization, two cells with respective base stations that provide overlapping coverage can experience severe interference if, for example, the downlink transmissions of one cell overlap in time with the uplink transmissions of the other cell or vice versa. By time synchronizing the base stations, the uplink transmissions to the base stations can be aligned in time and the downlink transmissions from the base stations can also be aligned in time. Timing synchronization can also simplify the handover process of a user terminal (e.g., a mobile phone) from one base station in one cell to another base station in an adjacent cell.

Network listening is a technique for performing timing synchronization and can be used as an alternative to techniques based on the direct reception of GPS synchronization signals and techniques based on the IEEE 1588 standard. For example, network listening can be used when these techniques do not work.

In general, timing synchronization via network listening involves a non-synchronized base station deriving and tracking its timing from signals transmitted downlink by a synchronized base station. The synchronized base station can be synchronized via direct reception of GPS synchronization signals or synchronization signals from some other global navigation satellite system (GNSS). Such a synchronized base station can be referred to as a primary synchronization source base station. Alternatively, the synchronized base station may, itself, be synchronized via network listening. Such a synchronized base station is not a primary synchronization source base station because it does not derive and track its timing directly from GPS synchronization signals but can be referred to as a timing donor base station. In the case where the non-synchronized base station derives and tracks its timing through one or more timing donor base stations ending with a primary synchronization source base station, the synchronization scheme can be referred to as multi-hop network listening.

For multi-hop network listening, the concept of a synchronization stratum can be introduced. A non-synchronized base station that performs synchronization using multi-hop network listening has a synchronization stratum determined based on the number of hops (or number of intervening timing donor base stations) between the non-synchronized base station and the primary synchronization source base station through which its timing is ultimately derived and tracked. For example, a non-synchronized base station that derives and tracks its timing from downlink signals transmitted by a primary synchronization source can be said to have a synchronization stratum of one, whereas a non-synchronized base station that derives and tracks its timing from downlink signals transmitted by a timing donor base station that, in turn, derives and tracks its timing from downlink signals transmitted by a primary synchronization source can be said to have a synchronization stratum of two.

In order for a non-synchronized base station to derive and track its timing from a signal transmitted downlink by a synchronized base station (either a timing donor base station or a primary synchronization source base station), the non-synchronized base station typically needs to be silent or not transmit downlink during the period of time over which the signal transmitted downlink by the synchronized base station is expected to be received. If the non-synchronized base station were to transmit downlink during this period of time, the non-synchronized base station's own downlink signal may overwhelm and prevent reception of the signal transmitted downlink by the synchronized base station. In an LTE network, the downlink signals transmitted by a synchronized base station that can be used by a non-synchronized base station to derive and track its timing, without causing backward compatibility issues due to the need for the non-synchronized base station to stop transmitting, include the downlink Cell-Specific Reference Signals (CRSs).

In one embodiment, the system and method of the present disclosure track the CRSs of a synchronized base station during guard periods of special subframes. In LTE, at least one special subframe is located in each LTE radio frame and is used to transition between downlink and uplink transmission. As defined by the LTE standard, the special subframe includes three parts: a downlink part or downlink pilot time slot (DwPTS), a guard period (GP), and an uplink part or uplink pilot time slot (UpPTS). To meet different network deployment arrangements, the lengths of these three fields in the special subframe (in terms of orthogonal frequency division multiplexing (OFDM) symbols) are configurable.

A non-synchronized base station can select a configuration for its special subframe such that it has a shorter DwPTS part than the special subframe of a synchronized base station to which the non-synchronized base station intends to synchronize its timing with. The shorter DwPTS part in the special subframe of the non-synchronized base station allows the non-synchronized base station to receive CRSs transmitted downlink from the synchronized base station during the DwPTS part of the synchronized base station's special subframe. The non-synchronized base station can then use the received CRSs to track and synchronize its timing to that of the synchronized base station.

To prevent a substantial loss in downlink throughput due to the non-synchronized base station using a shorter DwPTS part, tracking can be performed on a once per multiple radio frame basis as opposed to a once per radio frame basis. Not only does performing tracking on a once per multiple radio frame basis provide higher downlink throughput, but it can also provide support for a higher number of hops than would otherwise be possible on a per radio frame basis. These and other features are explained further below.

### II. CELL TIMING SYNCHRONIZATION VIA NETWORK LISTENING

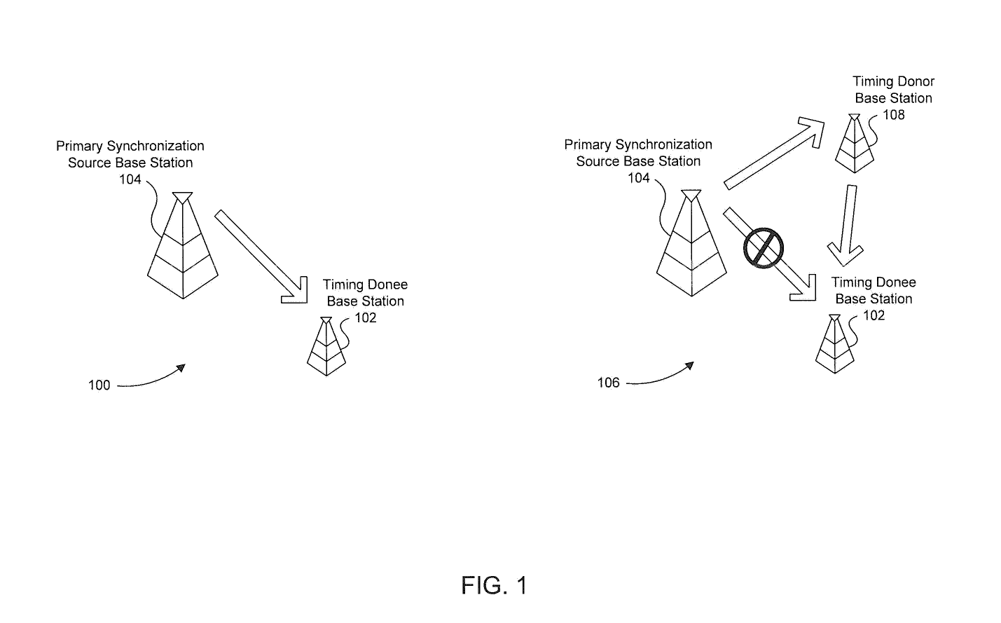

FIG. 1 illustrates two exemplary instances of cell timing synchronization via network listening in accordance with embodiments of the present disclosure. As mentioned above, cell timing synchronization is important in cellular networks that operate in the TDD mode to reduce interference. For example, without cell timing synchronization, two cells with respective base stations that provide overlapping coverage can experience severe interference if, for example, the downlink transmissions of one cell overlap in time with the uplink transmissions of the other cell or vice versa. By time synchronizing the base stations, the uplink transmissions to the base stations can be aligned in time and the downlink transmissions from the base stations can be aligned in time.

In the first instance 100 shown in FIG. 1, a timing donee base station (or non-synchronized base station) 102 synchronizes its timing with a primary synchronization source base station 104, both of which are operating in the TDD mode. Timing donee base station 102 specifically derives and tracks its timing from signals transmitted downlink by primary synchronization source base station 104. Primary synchronization source base station 104 synchronizes its own timing via direct reception of GPS synchronization signals or synchronization signals received from some other global navigation satellite system (GNSS).

In one embodiment, primary synchronization source base station 104 is a macro cell base station and timing donee base station 102 is a small cell base station that provides a small cellular coverage area that overlaps with a comparatively larger cellular coverage area provided by primary synchronization source base station 104. Timing donee base station 102 can be deployed, for example, in an area with high data traffic (or a so called hotspot) to increase capacity or in an area where the signal quality of primary synchronization source base station 104 is poor. Examples of small cell base stations include, in order of decreasing coverage area, microcell base stations, picocell base stations, and femtocell base stations or home base stations.

In the second instance 106 shown in FIG. 1, timing donee base station 102 is unable to directly synchronize its timing with primary synchronization source base station 104. For example, timing donee base station 102 may not be able to directly synchronize its timing with primary synchronization source base station 104 because it is unable to receive downlink signals from primary synchronization source base station 104 with adequate power or signal quality. However, timing donee base station 102 is able to receive downlink signals from another base station, timing donor base station 108. Timing donor base station 108 is, itself, synchronized via network listening with primary synchronization source base station 104. Timing donor base station 108 is not a primary synchronization source base station because it does not derive and track its timing directly from GPS synchronization signals but can nevertheless be used by timing donee base station 102 to derive and track its timing.

In the second instance 106, where timing donee base station 102 derives and tracks its timing from downlink signals from timing donor base station 108, the synchronization scheme can be referred to as multi-hop network listening. For multi-hop network listening, the concept of a synchronization stratum can be introduced. A non-synchronized base station that performs timing synchronization using multi-hop network listening, such as timing donee base station 102 in instance 106, has a synchronization stratum determined based on the number of hops (or number of intervening timing donor base stations) between the non-synchronized base station and the primary synchronization source base station through which its timing is ultimately derived and tracked. For example, a non-synchronized base station that derives and tracks its timing from downlink signals transmitted by a primary synchronization source can be said to have a synchronization stratum of one, whereas a non-synchronized base station that derives and tracks its timing from downlink signals transmitted by a timing donor base station that, in turn, derives and tracks its timing from downlink signals transmitted by a primary synchronization source can be said to have a synchronization stratum of two. Other synchronization stratums are possible, including synchronization stratums of three, four, and five, for example.

In order for a non-synchronized base station, such as timing donee base station 102 in FIG. 1, to derive and track its timing from a signal transmitted downlink by a synchronized base station (either a timing donor base station or a primary synchronization source base station), the non-synchronized base station typically needs to be silent or not transmit downlink during the period of time over which the signal transmitted downlink by the synchronized base station is expected to be received. If the non-synchronized base station were to transmit downlink during this period of time, the non-synchronized base station's own downlink signal may overwhelm and prevent reception of the signal transmitted downlink by the synchronized base station. In an LTE network, the downlink signals transmitted by a synchronized base station that can be used by a non-synchronized base station to derive and track its timing, without causing backward compatibility issues due to the need for the non-synchronized base station to stop transmitting, include the downlink Cell-Specific Reference Signals (CRSs).

In one embodiment, there are one to four CRSs in a cell, each of which defines a different antenna port. Each CRS includes predefined reference symbols inserted into the first and fifth OFDM symbols of each LTE subframe (and into the eighth and twelfth OFDM symbols of at least some of the LTE subframes) when the short cyclic prefix is used. Other symbol positions are used when the long cyclic prefix is used. CRSs are generally intended to be used by user terminals (e.g., mobile phones) served by a base station for, among other things, channel estimation and acquiring channel state information.

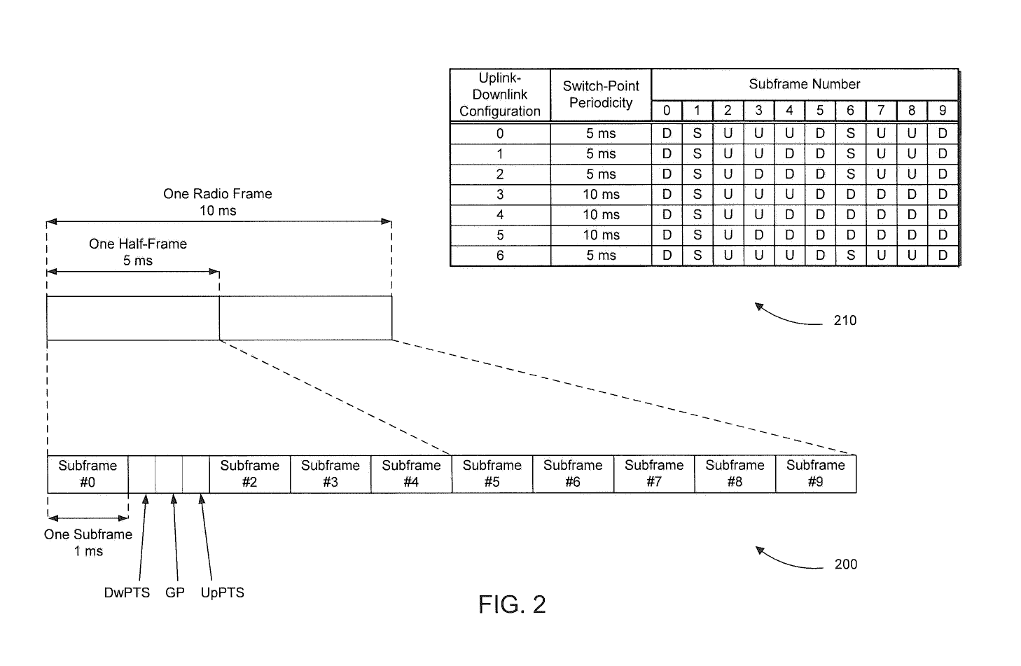

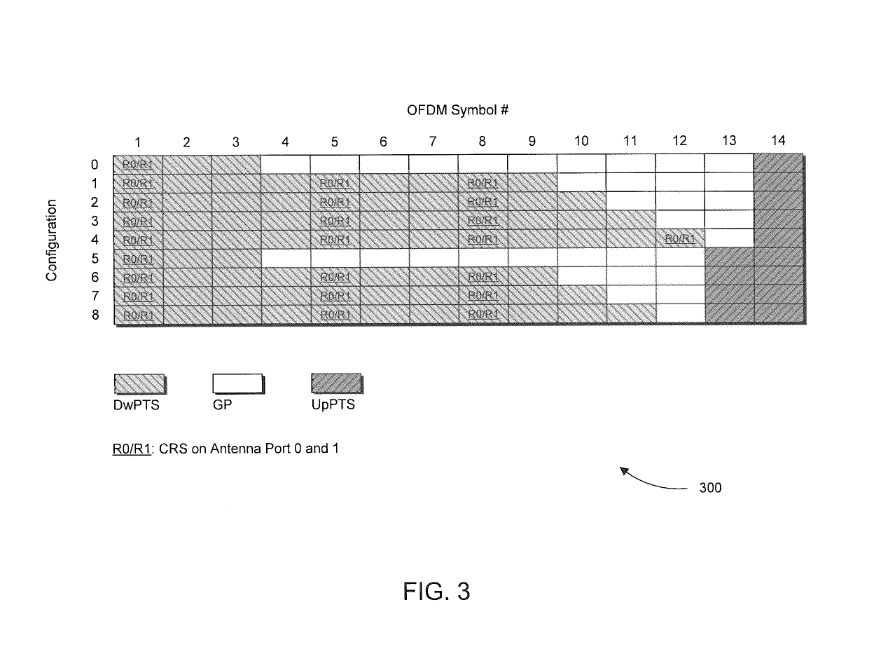

In one embodiment, the system and method of the present disclosure track the CRSs of a synchronized base station during guard periods of special subframes. In LTE, at least one special subframe is located in each LTE radio frame and is used to transition between downlink and uplink transmission. Further details of the LTE radio frame and special subframe configurations are described below in regard to FIGS. 2 and 3.

It should be noted that, in other embodiments, cell timing synchronization via network listening can be performed in a small cell farm with no macro cell coverage and where none of the small cells in the farm are able to synchronize their timings to GPS (or some other GNSS) and/or using the protocol defined by the IEEE 1588 standard. In such an instance, the system and method of the present disclosure can select one of the small cells in the farm to serve as the primary synchronization donor from which to synchronize all other small cells either directly or indirectly through one or more hops. For example, the system and method can randomly select one of the small cells in the farm as the primary synchronization donor or can select the small cell in the farm with strongest received power as the primary synchronization donor.

Referring now to FIG. 2, the general LTE-TDD radio frame configuration 200 and a table of the specific LTE-TDD uplink/downlink configurations 210 is illustrated. As shown, the general LTE-TDD frame configuration 200 is ten milliseconds in duration and consists of two five millisecond half-frames. Each half-frame is further divided into five subframes (0-4 and 5-9) that are each one millisecond in duration. The subframes typically carry 14 OFDM symbols.

Seven specific uplink/downlink configurations with either a five millisecond or a ten millisecond switch point periodicity are supported by the general LTE-TDD frame configuration 200 as shown in table 210, where “D” and “U” denote subframes reserved for downlink and uplink transmissions, respectively, and “S” denotes a special subframe. Each special subframe is divided into three fields: a downlink part or downlink pilot time slot (DwPTS), a guard period (GP), and an uplink part or uplink pilot time slot (UpPTS). The structure of the special subframe is shown in subframe one of the general LTE-TDD frame configuration 200. To meet different network deployment arrangements, these three fields in the special subframe are configurable and the different configurations are shown in table 300 of FIG. 3.

As illustrated in FIG. 3, there are a total of nine different special subframe configurations. The DwPTS portion of the special subframe is essentially a shorter downlink subframe and is used to transmit downlink data, including the CRSs for antenna ports 0 and 1 in the first, fifth, eighth, and twelfth symbols as shown. The length of the DwPTS portion can be varied from three OFDM symbols up to twelve OFDM symbols.

During operation of the LTE-TDD network, the GP portion of the special subframe is split between the downlink-to-uplink switch and the uplink-to-downlink switch within a complete LTE-TDD frame and provides the necessary guard time for these switches. For example, the GP portion is used to time align the uplink transmissions from the mobile devices within the network and is used to accommodate the time required by base stations within the LTE-TDD network to switch from uplink to downlink processing.

As mentioned above, the system and method of the present disclosure track the CRSs of a synchronized base station during the GP portion of special subframes. A non-synchronized base station can select a configuration for its special subframe such that it has a shorter DwPTS part than the special subframe of a synchronized base station to which the non-synchronized base station intends to synchronize its timing with. The shorter DwPTS part in the special subframe of the non-synchronized base station allows the non-synchronized base station to receive CRSs transmitted downlink from the synchronized base station during the DwPTS part of the synchronized base station's special subframe. The non-synchronized base station can then use the received CRSs to align its timing to the timing of the synchronized base station. For example, a non-synchronized base station can use configuration 0 or 5 shown in the table of FIG. 3, while the synchronized base station uses configuration 1, 2, 3, 4, 6, 7, or 8 also shown in the table of FIG. 3. Other configuration combinations are possible as will be appreciated by one of ordinary skill in the art based on the teachings herein, including configuration combinations for special subframes that use the extended cyclic prefix.

To prevent a substantial loss in downlink throughput due to the non-synchronized base station using a shorter DwPTS part, tracking can be performed on a once per multiple radio frame basis, as opposed to a once per radio frame basis. Not only does performing tracking on a once per multiple radio frame basis provide higher downlink throughput, but it can also provide support for a higher number of hops than would otherwise be possible on a per radio frame basis.

In one embodiment, tracking of the CRSs by a non-synchronized base station during a special subframe is performed by the non-synchronized base station every N frames, where N is an integer greater than one that is determined based on the synchronization stratum of the non-synchronized base station. The number of frames N can specifically be determined to be smaller for non-synchronized base stations with higher synchronization stratums to allow for multi-hop network listening.

In one embodiment, N is determined according to the following equation:

$$N = \frac{X}{{2}^{S - 1}}$$

where X is an integer number of frames and S is the synchronization stratum of the non-synchronized base station. The integer number of frames X can be set to a large value that improves downlink throughput but still allows a required timing synchronization to be meet. For example, X can be set to 32 frames. Thus, for a non-synchronized base station with a synchronization stratum of 3, N can be set to 8; for a non-synchronized base station with a synchronization stratum of 2. N can be set to 16; and for a non-synchronized base station with a synchronization stratum of 1, N can be set to 32.

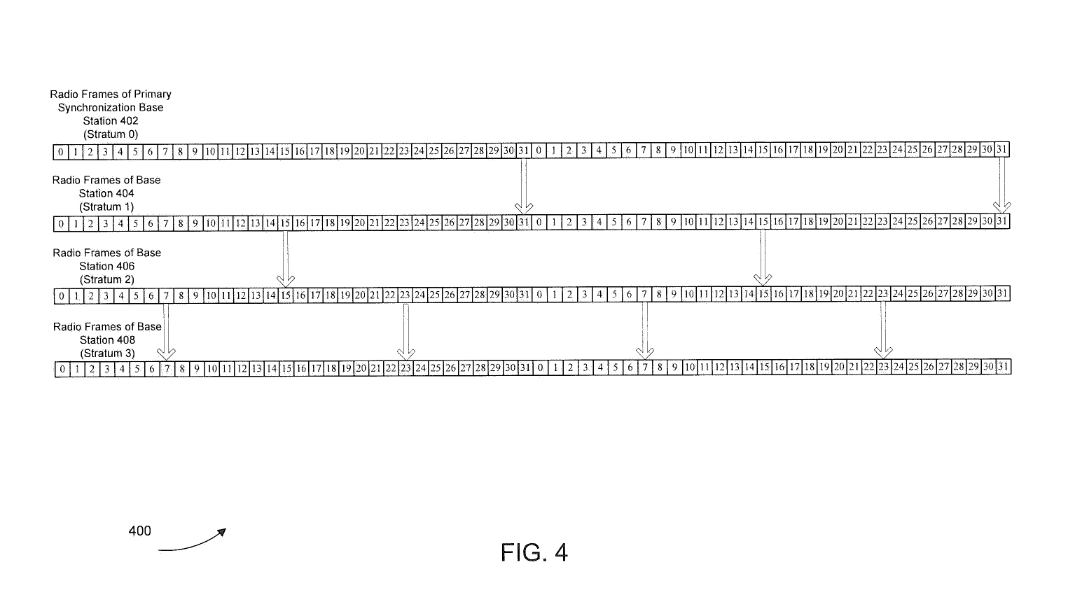

FIG. 4 illustrates two consecutive sets of 32 LTE radio frames for each of four base stations: 402, 404, 406, and 408. Base station 402 is a primary synchronization source base station. Base station 404 synchronizes its timing with primary synchronization source via network listening and thus has a synchronization stratum of 1. Base station 406 synchronizes its timing with base station 404 via network listening and thus has a synchronization stratum of 2. Finally, base station 408 synchronizes its timing with base station 406 via network listening and thus has a synchronization stratum of 3.

In accordance with the above equation, N is equal to 8 for base station 408, N is equal to 16 for a base station 406, and N is equal to 32 for base station 404. Frames that include a special subframe with a shortened DwPTS part are shown highlighted in grey. The arrows indicate frames from which CRSs are transmitted (beginning of arrow) and tracked (end of arrow). As can be seen in FIG. 4, base stations with synchronization stratums greater than 1 (e.g., base station 406) only track CRSs during the guard period of select ones of the special subframes with the shorter DwPTS part. In particular, base stations with synchronization stratums greater than 1 only track CRSs during the guard period of their special subframes with the shorter DwPTS part that occur during special subframes of its timing donor base station that have comparatively longer DwPTS parts. For example, base station 406 tracks CRSs during frame 15 but does not track CRSs during frame 31 given that its donor base station 404 uses a special subframe with the shorter DwPTS part in frame 31 to perform its own CRS tracking. Although, base station 406 does not track CRSs during frame 31, it still uses a special subframe with the shorter DwPTS part in frame 31 to prevent its downlink transmissions from interfering with base station 406 tracking CRSs during frame 31. It can be shown that, using the above equation with X equal to 32, a total of five hops can be supported.

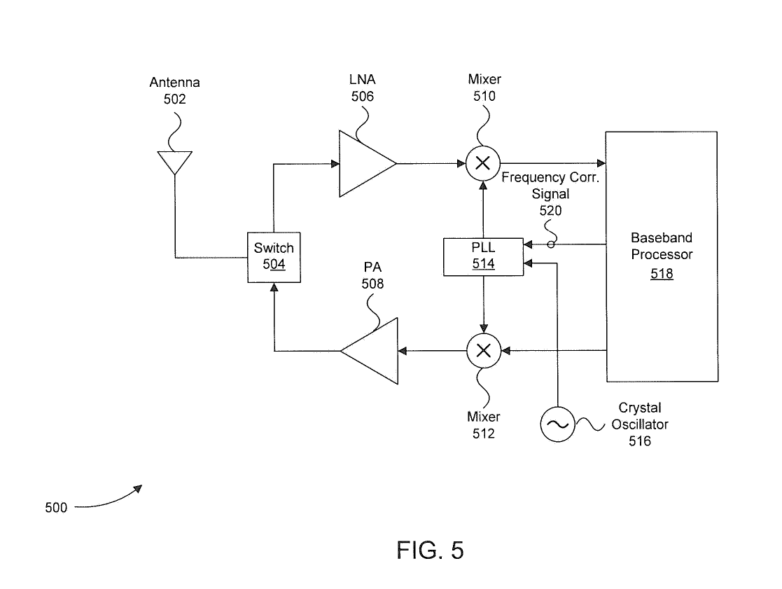

Referring now to FIG. 5, an exemplary block diagram of a base station 500 implementing cell synchronization via network listening in accordance with embodiments of the present disclosure is illustrated. Base station 500 includes an antenna 502, a switch 504, a low-noise amplifier (LNA) 506, a power amplifier 508, two mixers 510 and 512, a phased lock loop (PLL) 514, a crystal oscillator 516, and a baseband processor 518.

In operation, antenna 502 is configured to receive and transmit signals over a wireless channel at different times in accordance with a TDD mode. Switch 504 is configured to isolate signals received over the wireless channel by antenna 502 from those to be transmitted over the wireless channel by antenna 502. A signal received by antenna 502 is provided by switch 504 to LNA 506, which amplifies the signal. Mixer 510 mixes the amplified signal with a down-conversion clock provided by PLL 514 to down-convert the amplified signal to baseband or a suitable intermediate frequency. PLL 514 can derive the down-conversion clock from a reference clock provided by crystal oscillator 516. Once down-converted, mixer 510 provides the down-converted signal to baseband processor 518 for further processing.

For signals to be transmitted, baseband processor 518 first provides the signal to mixer 512 for up-conversion. Mixer 512 up-converts the signal provided by baseband processor 518 by mixing it with an up-conversion clock provided by PLL 514. PLL 514 can derive the up-conversion clock from the reference clock provided by crystal oscillator 516. Once up-converted, the signal can be amplified by power amplifier 508 and provided to antenna 502 through switch 504 for transmission over the wireless channel.

During initial power up, base station 500 can synchronize the frame start timing at the baseband processor 518 and the reference frequency of the reference clock provided by crystal oscillator 516 and/or the frequency of the up-conversion clock provided by PLL 514 with the timing and frequency of a timing donor base station. In particular, base station 500 can use, for example, the primary synchronization signal and the secondary synchronization signals transmitted by the timing donor base station to initially synchronize the reference frequency of the reference clock provided by crystal oscillator 516 and/or the frequency of the up-conversion clock provided by PLL 514. After base station 500 begins to transmit downlink, base station 500 can begin to track the timing of the timing donor base station using CRSs transmitted downlink by the timing donor base station in accordance with the method discussed above in regard to FIGS. 1-4. Baseband processor 518 can specifically extract these CRSs and use them to produce a frequency correction signal 520, which can be used to adjust the phase of the reference clock provided by crystal oscillator 516 and/or the phase of the up-conversion clock provided by PLL 514. Adjustments to the phase of the reference clock provided by crystal oscillator 516 and/or the phase of the up-conversion clock provided by PLL 514 are typically needed periodically due to drift associated with crystal oscillators, such as crystal oscillator 516.

It should be noted that base station 500 can perform initial synchronization using primary and secondary synchronization signals transmitted from a different base station than the base station from which base station 500 ultimately tracks CRSs to perform synchronization thereafter. In general, initial synchronization can require the reception of higher strength signals than synchronization performed thereafter. The ability of base station 500 to perform the different phases of synchronization using signals from two different base stations is advantageous because base stations with lower associated synchronization stratums are likely to have lower signal strengths at base station 500. Thus, base station 500 can potentially use CRSs transmitted from a base station with a lower synchronization stratum even though the signal strength from the base station is too weak to perform initial synchronization. Tracking CRSs from a base station with a lower synchronization stratum means fewer special subframes with a shortened DwPTS part are required on average, improving downlink throughput of base station 500.

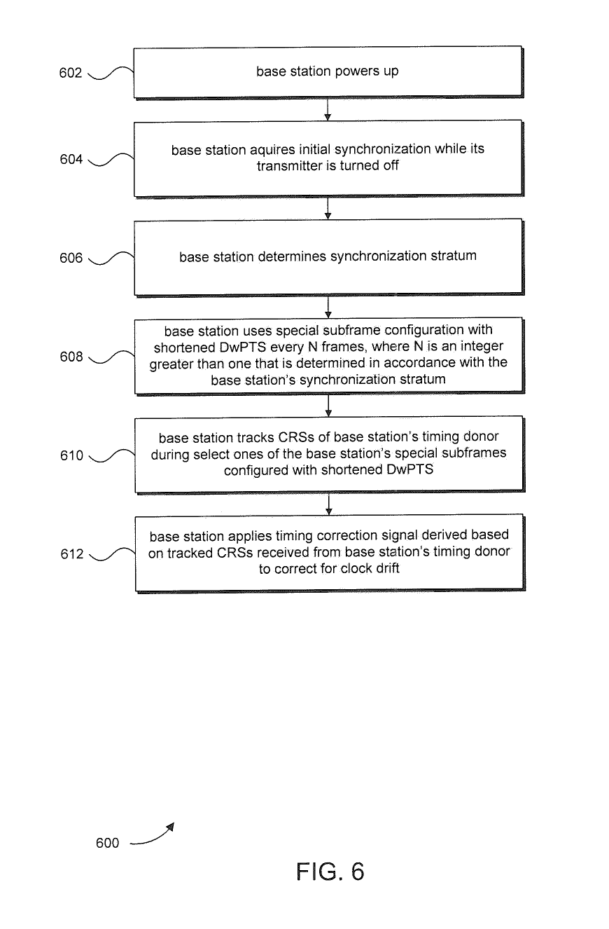

Referring now to FIG. 6, a flowchart 600 of an exemplary method of cell synchronization via network listening in accordance with embodiments of the present disclosure is illustrated. Flowchart 600 is performed by a base station, such as base station 500 shown in FIG. 5, for example.

Flowchart 600 begins at step 602. At step 602 the base station powers up. After powering up, the base station at step 604 acquires initial timing synchronization from a timing donor base station while its transmitter is turned off. For example, the base station can acquire initial timing synchronization using the primary synchronization signal and the secondary synchronization signals transmitted by the timing donor base station as explained above in regard to FIG. 5.

After step 604, flowchart 600 proceeds to step 606. At step 606, the base station determines its synchronization stratum. In one embodiment, the base station determines its synchronization stratum using a blind detection method. For example, the base station can examine the downlink frames it receives from nearby base stations and determine its synchronization stratum based on the base station that in can receive signals from with the smallest synchronization stratum (e.g., closest to 0).

After step 606, flowchart 600 proceeds to step 608. At step 608, the base station uses a special subframe configuration with a shortened DwPTS part every N frames, where N is an integer determined in accordance with the base stations synchronization stratum. In one embodiment, N is determined according to the following equation:

$$N = \frac{X}{{2}^{S - 1}}$$

where X is an integer number of frames and S is the synchronization stratum of the non-synchronized base station. The integer number of frames X can be set to a large value that improves downlink throughput but still allows a required timing synchronization to be met. For example, X can be set to 32 frames.

After step 608, flowchart 600 proceeds to step 610. At step 610, the base station tracks CRSs of the base station's timing donor during select ones of the base station's special subframes configured with a shortened DwPTS part. In particular, the base station only tracks CRSs during the guard period of its special subframes with the shorter DwPTS part that occur during special subframes of its timing donor base station that have comparatively longer DwPTS parts.

After step 610, flowchart 600 proceeds to step 612. At step 612, the base station applies a frequency correction signal derived based on the tracked CRSs received from the base station's timing donor to correct for clock drift.

### III. EXAMPLE COMPUTER SYSTEM ENVIRONMENT

It will be apparent to persons skilled in the relevant art(s) that various elements and features of the present disclosure, as described herein, can be implemented in hardware using analog and/or digital circuits, in software, through the execution of instructions by one or more general purpose or special-purpose processors, or as a combination of hardware and software.

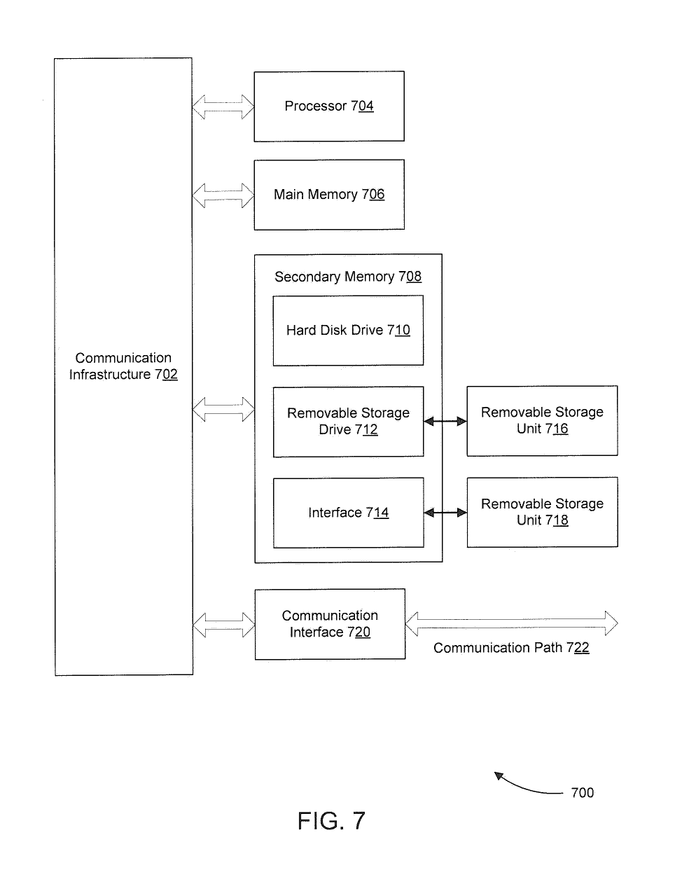

The following description of a general purpose computer system is provided for the sake of completeness. Embodiments of the present disclosure can be implemented in hardware, or as a combination of software and hardware. Consequently, embodiments of the disclosure may be implemented in the environment of a computer system or other processing system. An example of such a computer system 700 is shown in FIG. 7. Modules depicted in FIG. 5 may execute on one or more computer systems 700. Furthermore, each of the steps of the method depicted in FIG. 6 can be implemented on one or more computer systems 700.

Computer system 700 includes one or more processors, such as processor 704. Processor 704 can be a special purpose or a general purpose digital signal processor. Processor 704 is connected to a communication infrastructure 702 (for example, a bus or network). Various software implementations are described in terms of this exemplary computer system. After reading this description, it will become apparent to a person skilled in the relevant art(s) how to implement the disclosure using other computer systems and/or computer architectures.

Computer system 700 also includes a main memory 706, preferably random access memory (RAM), and may also include a secondary memory 708. Secondary memory 708 may include, for example, external double date rate memory (not shown), a hard disk drive 710, and/or a removable storage drive 712, representing a floppy disk drive, a magnetic tape drive, an optical disk drive, or the like. Removable storage drive 812 reads from and/or writes to a removable storage unit 716 in a well-known manner. Removable storage unit 716 represents a floppy disk, magnetic tape, optical disk, or the like, which is read by and written to by removable storage drive 712. As will be appreciated by persons skilled in the relevant art(s), removable storage unit 716 includes a computer usable storage medium having stored therein computer software and/or data.

In alternative implementations, secondary memory 708 may include other similar means for allowing computer programs or other instructions to be loaded into computer system 700. Such means may include, for example, a removable storage unit 718 and an interface 714. Examples of such means may include a program cartridge and cartridge interface (such as that found in video game devices), a removable memory chip (such as an EPROM, or PROM) and associated socket, a thumb drive and USB port, and other removable storage units 718 and interfaces 714 which allow software and data to be transferred from removable storage unit 718 to computer system 700.

Computer system 700 may also include a communications interface 720. Communications interface 720 allows software and data to be transferred between computer system 700 and external devices. Examples of communications interface 720 may include a modem, a network interface (such as an Ethernet card), a communications port, a PCMCIA slot and card, etc. Software and data transferred via communications interface 720 are in the form of signals which may be electronic, electromagnetic, optical, or other signals capable of being received by communications interface 720. These signals are provided to communications interface 720 via a communications path 722. Communications path 722 carries signals and may be implemented using wire or cable, fiber optics, a phone line, a cellular phone link, an RF link and other communications channels.

As used herein, the terms “computer program medium” and “computer readable medium” are used to generally refer to tangible storage media such as removable storage units 716 and 718 or a hard disk installed in hard disk drive 710. These computer program products are means for providing software to computer system 700.

Computer programs (also called computer control logic) are stored in main memory 706 and/or secondary memory 708. Computer programs may also be received via communications interface 720. Such computer programs, when executed, enable the computer system 700 to implement the present disclosure as discussed herein. In particular, the computer programs, when executed, enable processor 704 to implement the processes of the present disclosure, such as any of the methods described herein. Accordingly, such computer programs represent controllers of the computer system 700. Where the disclosure is implemented using software, the software may be stored in a computer program product and loaded into computer system 700 using removable storage drive 712, interface 714, or communications interface 720.

In another embodiment, features of the disclosure are implemented primarily in hardware using, for example, hardware components such as application-specific integrated circuits (ASICs) and gate arrays. Implementation of a hardware state machine so as to perform the functions described herein will also be apparent to persons skilled in the relevant art(s).

### IV. CONCLUSION

Embodiments have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the disclosure that others can, by applying knowledge within the skill of the art, readily modify and/or adapt for various applications such specific embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

What is claimed is:

1. A method for performing timing synchronization in a cellular network comprising:
determining a synchronization stratum of a timing donee base station;
configuring a special subframe of the timing donee base station with a shorter downlink portion than a special subframe of a primary synchronization source base station every N frames in a plurality of frames, wherein N is an integer greater than one that is determined based on the synchronization stratum of the timing donee base station;
receiving a reference signal during special subframes of the timing donee base station that are in the plurality of frames and configured with the shorter downlink portion; and
adjusting a phase of a clock used by the timing donee base station to upconvert symbols for downlink transmission based on the reference signal.

2. The method of claim 1, wherein the synchronization stratum of the timing donee base station corresponds to a number of hops between the timing donee base station and the primary synchronization source.

3. The method of claim 1, wherein the reference signal is received from the primary synchronization source base station.

4. The method of claim 1, wherein the reference signal is received from a timing donor base station within one less hop of the primary synchronization source than the timing donee base station.

5. The method of claim 4, wherein the reference signal is only received during a guard period of select ones of the special subframes of the timing donor base station configured with the shorter downlink portion that occur during special subframes of the timing donor base station that have comparatively longer downlink portion.

6. The method of claim 4, wherein the timing donor base station acquires timing synchronization directly from the primary synchronization source base station.

7. The method of claim 6, wherein the primary synchronization source base station acquires timing synchronization directly from a global navigation satellite system.

8. The method of claim 1, further comprising:
determining N according to the following equation:
$$N = \frac{X}{{2}^{S - 1}}$$
where X is an integer number of frames and S is the synchronization stratum of the timing donee base station.

9. The method of claim 1, wherein the timing donee base station performs initial timing synchronization using signals received from a different base station than a timing donor base station from which the reference signal is received.

10. The method of claim 1, wherein the reference signal is a cell specific reference signal.

11. The method of claim 1, wherein determining the synchronization stratum of the timing donee base station further comprises:
using a blind determination technique to determine the synchronization stratum of the timing donee base station.

12. A method for performing timing synchronization in a cellular network comprising:
configuring a special subframe of a timing donee base station with a shorter downlink portion than a downlink portion of a special subframe of a primary synchronization source base station every N frames in a plurality of frames, wherein N is an integer greater than one; and
adjusting a phase of a clock used at the timing donee base station to upconvert symbols for downlink transmission based on a reference signal received from a timing donor base station during a guard period of a first set of special subframes of the timing donee base station that are in the plurality of frames and configured with the shorter downlink portion.

13. The method of claim 12, wherein the first set of the special subframes with the shorter downlink portion occur during special subframes of the timing donor base station with comparatively longer downlink portions.

14. The method of claim 13, wherein a second set of the special subframes with the shorter downlink portions occur during special subframes of the timing donor base station with comparatively smaller or the same length downlink portions as the second set of the special subframes with the shorter downlink portions.

15. The method of claim 12, further comprising:
determining N based on a synchronization stratum of the timing donee base station.

16. The method of claim 15, further comprising:
determining N according to the following equation:
$$N = \frac{X}{{2}^{S - 1}}$$
where X is an integer number of frames and S is the synchronization stratum of the timing donee base station.

17. A timing donee base station comprising:
a crystal oscillator configured to provide a reference clock;
a phased lock loop configured to use the reference clock to produce an up-conversion clock;
a mixer configured to use the up-conversion clock to up-convert a symbol for transmission over a wireless link;
a baseband processor configured to:
configure a special subframe with a shorter downlink portion than a special subframe of a primary synchronization source base station every N frames in a plurality of frames, wherein N is an integer greater than one, and
adjust a phase of the up-conversion clock or the reference clock based on a reference signal received from a timing donor base station during a guard period of select ones of special subframes of the timing donee base station that are in the plurality of frames and configured with the shorter downlink portion.

18. The timing donee base station of claim 17, wherein the select ones of the special subframes with the shorter downlink portions occur during special subframes of the timing donor base station with comparatively longer downlink portions.

19. The timing donee base station of claim 17, wherein the baseband processor is further configured to determine N based on a synchronization stratum of the timing donee base station.

20. The timing donee base station of claim 19, wherein the baseband processor is further configured to determine N according to the following equation:
$$N = \frac{X}{{2}^{S - 1}}$$
where X is an integer number of frames and S is the synchronization stratum of the timing donee base station.

21. The timing done base station of claim 17, wherein the timing donee base station is a small cell base station and the primary synchronization source base station is a macro cell base station.
